(19) United States
(12) Patent Application Publication
(10) Pub. No.: US 2012/0276504 A1
(43) Pub. Date: Nov. 1, 2012

(54) Talking Teacher Visualization for Language Learning

(75) Inventors: Gang Chen, Beijing (CN); Weijiang Xu, Beijing (CN); Lijuan Wang, Beijing (CN); Matthew Robert Scott, Beijing (CN); Frank Kao-Ping Soong, Beijing (CN); Hao Wei, Beijing (CN)

(73) Assignee: Microsoft Corporation, Redmond, WA (US)

(21) Appl. No.: 13/098,217

(22) Filed: Apr. 29, 2011

(51) Int. Cl. G09B 19/06

(52) U.S. Cl. 434/157

(57) ABSTRACT

A representation of a virtual language teacher assists in language learning. The virtual language teacher may appear as a “talking head” in a video that a student views to practice pronunciation of a foreign language. A system for generating a virtual language teacher receives input text. The system may generate a video showing the virtual language teacher as a talking head having a mouth that moves in synchronization with speech generated from the input text. The video of the virtual language teacher may then be presented to the student.

### BACKGROUND

Learning correct pronunciation is one of the most difficult tasks for students of foreign languages. Receiving personalized instruction from a teacher that is a native speaker of the language may be the best way to learn correct pronunciation of a foreign language. However, it is not always possible for many students learning a foreign language to interact with a native speaker of that language. Some teachers may not be native speakers of the language they teach. Some students may wish to study on their own or may have only limited access to language teachers. Another source of instruction is needed for times and places when a native speaker is not available to teach pronunciation.

Students may study pronunciation without a teacher by listening to audiotapes or watching videos. Language teachers who are not native speakers of the target language may use prerecorded materials to supplement their instruction. However, audiotapes and videos are not customizable and a student is limited to practicing only in the words and phrases that are contained on the audiotapes and videos. Additionally, audiotapes and videos are static and the student may lose interest after repeatedly listening to or watching the same content multiple times.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The subject of this disclosure is directed to generation of a virtual language teacher. The virtual language teacher may be visually represented as a “talking head” that shows a photorealistic or cartoon image of the head and shoulders of a person. The system that generates the virtual language teacher may receive input text and from the input text create audio of a computer voice “reading” the text and a talking head with a mouth of that moves as the input text is “read.” The resulting impression for the student is of a talking head that appears to speak the input text. The student can both see how the mouth moves and hear pronunciation of the input text.

The virtual language teacher may be implemented in many different ways. In one implementation, a teacher, who is not a native speaker of the language being taught, may enter sentences from a textbook into a system for generating the virtual language teacher and then obtain a video that he or she can show to students. The pronunciation instruction provided by the virtual language teacher may complement the textbook and other instruction provided by the teacher. In another implementation, a student may access a website and view previously generated videos showing a virtual language teacher or the student may input text that he or she wishes to practice and receive a custom virtual language teacher video. The student may also manipulate the video of the virtual language teacher in multiple ways that can assist learning pronunciation of a foreign language.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 shows an illustrative process of generating a talking head video for a student to view when studying a foreign language.

FIG. 2 shows an illustrative user interface of a video player displaying a talking head video.

FIG. 3 is block diagram of an illustrative computing device usable to generate talking head videos.

FIG. 4 is an illustrative architecture showing generation and consumption of a talking head video at a local computing device.

FIG. 5 is an illustrative architecture showing a network computing device usable to provide talking head videos.

FIG. 6 is a flowchart showing an illustrative method of modifying a talking head video.

FIG. 7 is a flowchart showing an illustrative method of obtaining talking head videos and identifying lip-sync errors.

### DETAILED DESCRIPTION

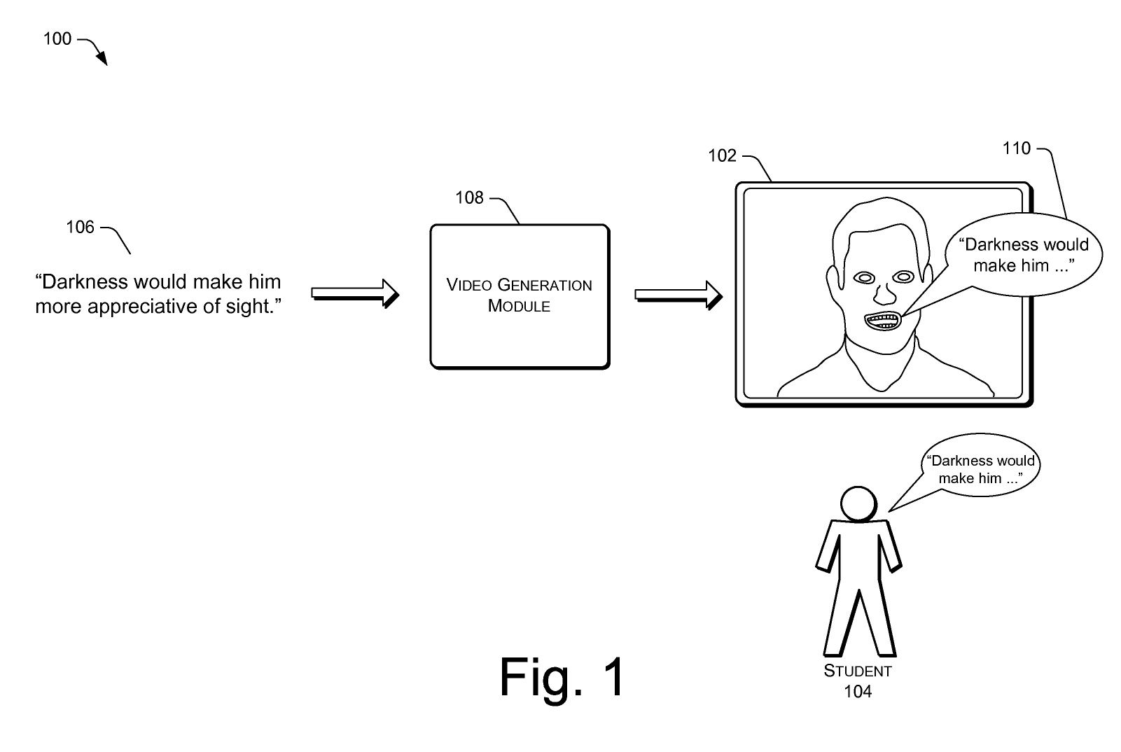

FIG. 1 shows an illustrative process 100 for generating a talking head video 102 for a student 104 to view when studying a foreign language. The talking head video 102 generally shows an image of a person's head and shoulders. However, more or less of the person may be shown in the video. Generation of the talking head video 102 may begin with a portion of input text 106. Here, the illustrative input text 106 is the English sentence “Darkness would make him more appreciative of sight.” The input text 106 may be at any length and is not limited to only single sentences. For example, a single word or phrase that is less than the length of a sentence may be used as the input text 106. Also, a portion of input text 106 longer than a single sentence such as a paragraph or an entire document like a book may be the basis for generating a talking head video 102. The input text 106 may be in English, as in this example, or in any other language. The input text 106 or may also include more than one language. For example, an English sentence may include a French word such as “concierge.”

The input text 106 may be provided by the student 104, a teacher preparing study materials for students, a website or other electronic document that can be automatically scanned or mined for input text, or by another source. The input text may be received by a video generation module 108 and used as the basis for generating the talking head video 102. The video generation module 108 may function together with other software or hardware modules to create the talking head video 102. The video generation module 108 may be contained within a computing device used by the student 104 (e.g., a personal computer, mobile computing device, etc.), contained in a network or cloud-based implementation and accessed from a terminal device (e.g., a personal computer with a web browser, a thin client, etc.), maintained on a Web server accessible via a web-based interface, or in any other type of computing device.

The talking head video 102 is generated by the video generation module 108 and includes a talking head image and speech 110 that corresponds to the sound of a person speaking or reading the input text 106. The talking head image may move its mouth as sounds corresponding to words of the input text are produced. The sound of the speech 110 portion of the talking head video 102 is illustrated here graphically as a text bubble. However, the talking head video 102 does not necessarily display the input text 106 as a text bubble. Rather, the talking head video 102 includes a video portion which shows an image of a person and an audio portion which is the sound of the input text 106 being spoken. Both the image of the talking head (i.e., the face shown in the talking head video 102) and the speech 110 corresponding to the input text 106 may be machine generated. The talking head video 102 may also include a display of the input text 106 as subtitles, in a text bubble, and the like.

The student 104 can view the talking head video 102 on a computer monitor, a television, a screen in a classroom, or any other type of display device. Although the consumer of the talking head video 102 is shown here as the student 104, any person including the teacher or someone fluent in the language of the input text 106 can view the talking head video 102. Thus, the student 104 shown in FIG. 1 may be broadly representative of a viewer of the talking head video 102 whether or not that viewer is studying the language spoken by the talking head video 102. During language study, the student 104 may repeat the speech 110 of the talking head video 102 thereby practicing pronunciation of the input text 106.

### Illustrative User Interface

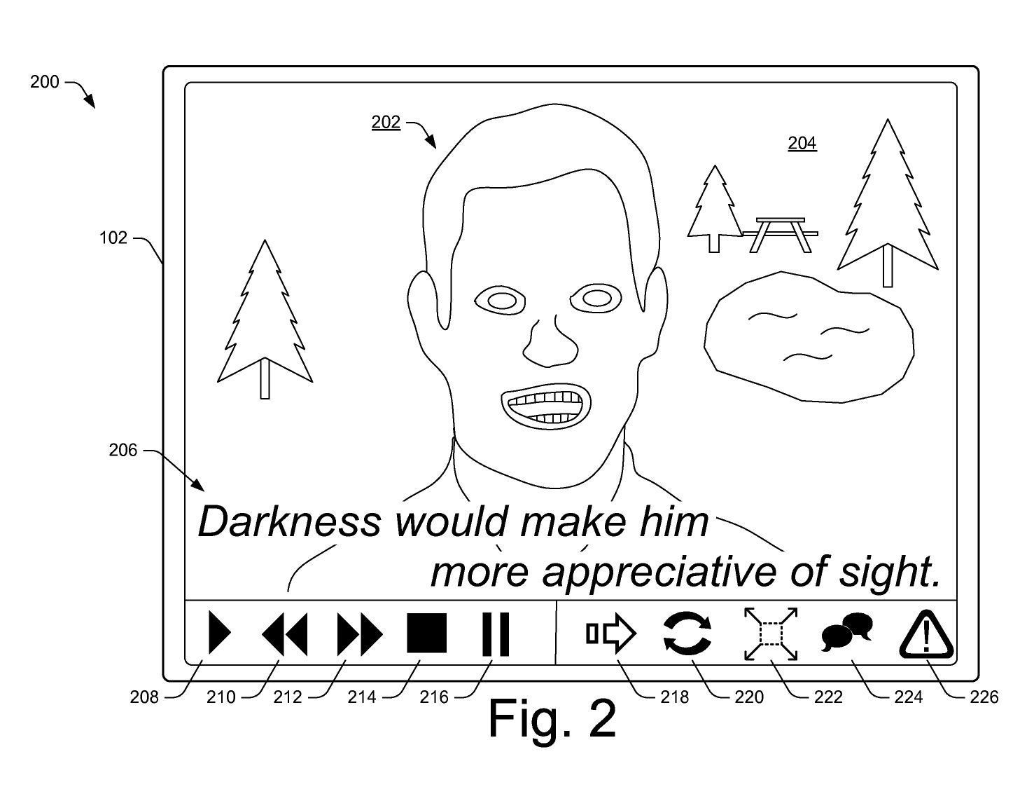

FIG. 2 shows an illustrative user interface 200 of a video player for viewing the talking head video 102. The talking head video 102 as displayed on the video player may include a talking head 202 shown here as a representation of the head and shoulders of a person. The mouth of the talking head 202 moves together with the playback of the voice generated from the input text. When the mouth movements of the talking head 202 are synchronized with the sound of the voice it appears as if the talking head 202 is speaking or lip syncing the input text. Visualizations of mouth movements may assist the student in learning how to move his or her mouth while practicing pronunciation of a foreign language by allowing the student to see mouth movements corresponding to phonemes in the foreign language.

The talking head video 102 may show the talking head 202 in front of a background 204. The background 204 may be a color, a pattern, an image such as a scene of trees and a lake, an image with one or more moving elements, or a moving video. However, the background 204 may be omitted from the talking head video 102 and in such cases the talking head 202 may be shown in front of a white image or portions of the video that would otherwise display background may be “transparent” allowing an underlying image to show through (e.g., a desktop pattern of a computer graphical user interface).

In some implementations, the talking head video 102 may display the input text as subtitles 206 or as any other type of textual display (e.g., a text bubble). The subtitles 206 may be presented in any font style and placed on any portion of the screen with a horizontal or vertical orientation. The orientation of the subtitles 206 may be based upon their writing style of the language of the input text (e.g., Mandarin Chinese may be shown vertically and English may be shown horizontally). The subtitles 206 may be displayed on the talking head video 102 at the same or approximately the same time that the talking heads 202 speaks the corresponding words of the input text. The subtitles 206 may appear to scroll across the display (e.g., similar to a stock ticker) or appear without moving and then be replaced by the next portion of the input text (e.g., similar to lyrics shown on a monitor for karaoke). The word or portion of the input text that is being spoken by the talking head 202 may be highlighted or otherwise visually emphasized in the subtitles 206.

The video player may also include a series of controls for playback of the talking head video 102. These controls are shown in FIG. 2 as “on-screen” controls that appear in the video player window together with the talking head video 102. However, the controls may be implemented using any type of technology or interface such as tangible buttons on the surface of a device (e.g., computer keyboard, video player, set-top box, monitor, remote control, mobile phone, etc.), soft buttons on a touch screen, icons on a graphical user interface, voice commands detected by a microphone, and the like.

The controls may include several “conventional” video player controls such as play 208, rewind 210, fast forward 212, stop 214, and pause 216. The controls may also include further controls that may assist a student in learning a foreign language from a virtual language teacher.

A slow 218 control may decrease the speed or slow down the playback of the talking head video 102. The slow 218 control may reduce both the speed of the video playback and of the audio playback equally so that the voice reading the input text remain synchronized with the mouth movements of the talking head 202. The amount that playback is slowed may be user configurable (e.g., 10% speed reduction, 20% speed reduction, etc.). Repeated activation of the slow 218 control (e.g., clicking twice with a mouse) may increase the amount that playback is slowed.

A loop 220 control may allow the student or other viewer of the talking head video 102 to replay continuously a portion of the talking head video 102. For example, if there is a part of the input text that a student has difficulty pronouncing correctly, he or she may activate the loop 220 control and focus on practicing just a portion of the talking head video 102. When a viewer activates the loop 220 control, the video player may repeatedly playback a portion of the talking head video 102 that immediately preceded activation of the loop 220 control. For example, activation of the loop 220 control may cause the previous 5 seconds of the talking head video 106 to be continually replayed. The length of the portion that is looped (e.g., 5 seconds) may be user configurable.

Alternatively, the loop 220 control may be activated twice: once to indicate a start of the loop and a second time to indicate an end of the loop. For example, the student may activate the loop 220 control at a first point prior to a portion of the talking head video 102 that he or she wishes to repeat and then activate the loop 220 control again at a second point once the portion of interest has finished. Subsequently, the video player may repeatedly playback or loop the video between the first point and the second point as indicated by activation of the loop 220 control.

An additional control that may be available to a viewer of the talking head video 102 is a zoom 222 control. The zoom 222 control may change the image displayed in the talking head video 102 so that it appears to zoom in or enlarge the mouth region of the talking head 202. Zooming in on the mouth may allow a student to see more clearly the lip, mouth, and tongue movements that create correct pronunciation. The region that is displayed in response to the zoom 220 control may also be user configurable. The viewer may select a tighter zoom that shows only the mouth or a wider zoom on the lower half of the face of the talking head 202, etc.

Many of these controls may be used together with other controls to customize playback of the talking head video 102. For example, a user may select both the slow 218 control and the zoom 222 control and in response the video player may show a slow speed playback that enlarges the mouth region of the talking head 202. Each of the slow 218 command and the zoom 222 command may separately or together be combined with the loop 220 command.

Subtitles 206, or other textual representations of the input text, may be activated or deactivated by a subtitle 224 command. A student, or a teacher operating playback of a talking head video 102, may choose to turn off the subtitles 206 by activating the subtitle 224 command. In some implementations, repeated activation (e.g., pressing a button on a remote control more than once) of the subtitle 224 command may change the manner in which the subtitles 206 are displayed for example by switching between “karaoke” style subtitles and a text bubble. Activation or deactivation of subtitles 206 using the subtitle 224 command may be combined with a combination of the slow 218 command, loop 220 command, and/or zoom 222 command.

Generation of the talking head video 102 is intended to create a video in which mouth movements are synchronized and correspond to the sounds of the speech created from the input text. However, there may be times when the audio of the speech and the movements of the mouth of the talking head 202 are out of phase and it appears as if the talking head 202 is doing a poor job of lip-synching to the speech. Viewers of the talking head video 102, particularly when the video is viewed by a large number of viewers such as a video available on a website, may help identify portions of a talking head video 102 in which the mouth and the spoken words appear out of sync. A viewer can indicate the existence of this type of error by activating a “lip-sync error” 226 command. Indications of a lip-sync error may be received anonymously from multiple viewers and used by a creator of the talking head video 102 (e.g., an entity controlling a network server computer that made the talking head video 102 available over a network) to correct or regenerate the talking head video 102 without the lip-sync error.

### Illustrative Computing Device

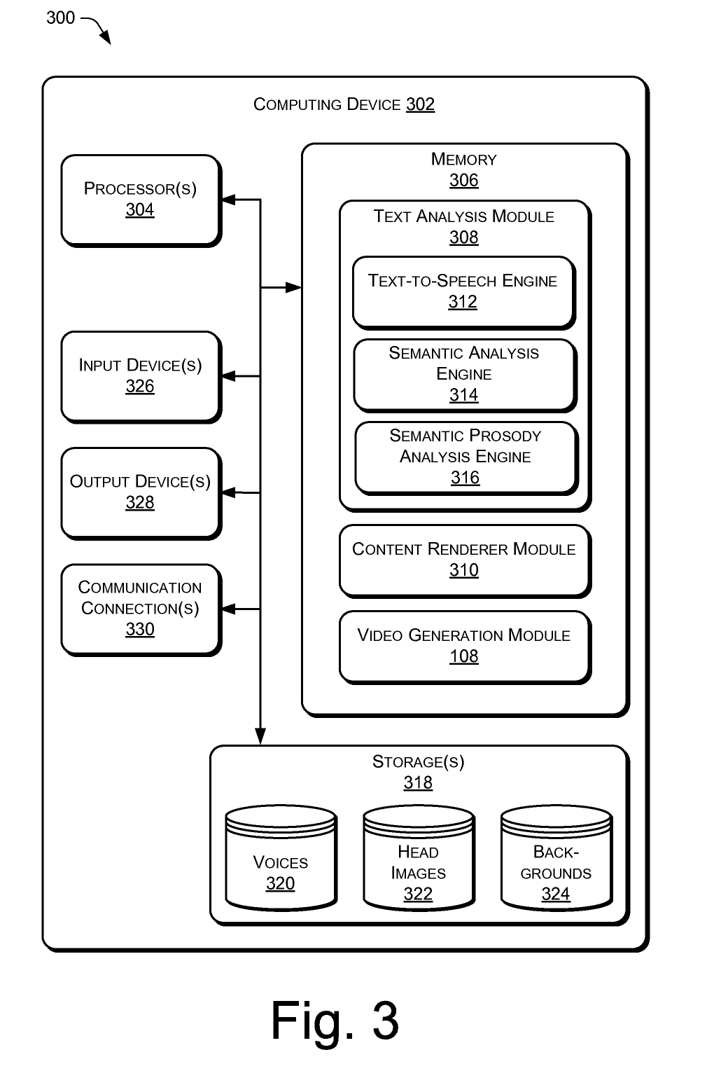

FIG. 3 is a block diagram 300 showing an illustrative computing device 302. The computing device 302 may be configured as any suitable system capable of running, in whole or part, the video generation module 108. The computing device 302 comprises one or more processor(s) 304 and a memory 306. The processor(s) 304 may be implemented as appropriate in hardware, software, firmware, or combinations thereof Software or firmware implementations of the processor(s) 304 may include computer- or machine-executable instructions written in any suitable programming language to perform the various functions described.

The memory 306 may store programs of instructions that are loadable and executable on the processor(s) 304, as well as data generated during the execution of these programs. Examples of programs and data stored on the memory 306 may include an operating system for controlling operations of hardware and software resources available to the computing device 302, drivers for interacting with hardware devices, communication protocols for sending and/or receiving data to and from other computing devices, as well as additional software applications. Depending on the configuration and type of computing device 302, the memory 306 may be volatile (such as RAM) and/or non-volatile (such as ROM, flash memory, etc.).

The memory 306 may contain multiple modules utilized for generation of a virtual language teacher such as a text analysis module 308, a content renderer module 310, and the video generation module 108.

The text analysis module 308 may receive input text and use the input text as a starting point for generating a talking head video. In some implementations, the input text may be sufficient input for the computing device 302 to generate a talking head video. Additional instructions or input may be unnecessary. The text analysis module 308 may include a text-to-speech engine 312, a semantic analysis engine 314, and a semantic prosody analysis engine 316.

The text-to-speech engine 312 may use any conventional text-to-speech algorithm for converting the input text into an audio file that represents or approximates human speech of the input text. The language of the input text may be detected automatically by the text-to-speech engine 312 or the user may be asked to identify the language of the input text. The user may also be asked to identify or select a dialect or country in order to select an appropriate algorithm for the text-to-speech engine 312. For example, the same input text may lead to a different audio output depending on whether or not the resultant speech is rendered in American English or British English. The voice of the talking head, as generated by a text-to-speech algorithm, may be fully user customizable such as, for example, being selectable as male or female speech or as having a voice similar to a famous person, etc. The voice of the talking head (i.e., the text-to-speech algorithm used) may also be selected based upon informational content (e.g. meaning, emotion, and the like) inferred from the input text as discussed below.

The semantic analysis engine 314 may be configured to infer a meaning of the input text. Semantic analysis of the input text may identify a theme, a topic, keywords, and the like associated with the input text. The inference may be performed by any conventional textual analysis or semantic analysis algorithm. For example, if the input text includes the words “Eiffel Tower” the semantic analysis engine 314 may infer that the input text is related to the Eiffel Tower, Paris and/or France. Additionally, if the input text is from a known source such as a book, poem, speech, etc. the semantic analysis engine 314 may identify the source of input text (e.g., by an Internet search or the like) and infer the meaning of the input text based on the source. For example, the phrase “darkness would make him more appreciative of site” may be associated with an essay by Helen Keller and the semantic analysis engine 314 may infer that the input sentence has a meaning related to blindness and/or physical disabilities.

The semantic prosody analysis engine 316 may be configured to infer an emotion of the input text. Semantic prosody or discourse prosody describes the way in which words or combination of words can be associated with positive or negative emotions. Analysis of semantic prosody may determine the attitude of a writer towards a topic of his or her writing, emotional judgment or evaluation conveyed in the writing, an emotional state of the author when writing, and/or the intended emotional communication or emotional effect the author wishes to have on the reader.

The emotion associated with the input text by the semantic prosody analysis engine 316 may be selected from a defined set of emotions including, but not limited to, joy, sadness, fear, anger, surprise, suspicion, disgust, and trust. The semantic prosody analysis engine 316 may also represent the inferred emotion as having a relative strength such as on a continuum between two opposite emotions. This representation may be numerical. For example, on a joy-sadness continuum +100 may represent pure joy, 0 may represent neither joy nor sadness, and −100 may represent pure sadness.

The meaning of the input text as inferred by the semantic analysis engine 314, the emotion of the input text as inferred by the semantic prosody analysis engine 316, or a combination of the inferred meaning and inferred emotion may be used by the text-to-speech engine 312 to select an appropriate text-to-speech algorithm for converting the input text into an audio file. Thus, in some implementations, the text-to-speech engine 312 may be configured to select a voice for an audio file based on the meaning and/or emotion of the input text. For example, input text having sad emotional content may be rendered as an audio file that uses a sad voice. Also, input text that has a meaning closely associated with a particular individual may be rendered using the voice of that individual (e.g. the phrase “we have nothing to fear but fear itself” may be converted into an audio file with a voice that sounds like Franklin D. Roosevelt).

The content renderer module 310 may generate a video of a talking head having mouth movements based on the input text. The talking head may be represented as a photorealistic image based upon a still photograph or a video of an actual person. The talking head may also be based upon a computer-generated facial model, a cartoon face, a drawing, or any other image of a face. Analysis of the input text by the content renderer module 310 may cause the mouth of the talking head to move in accordance with mouth movements of a native speaker speaking the input text. In one implementation, the input text may be broken down into a series of phonemes which each corresponds with a mouth image. The mouth of the talking head may be morphed through a series of mouth images corresponding to the phonemes represented by the input text.

The content renderer module 310 may be configured to select an image for the talking head based on the meaning and/or emotion of the input text as inferred by the semantic analysis engine 314 and/or semantic prosody analysis engine 316. The face selected to be shown as the talking head may be a face or head image that appears to display a same emotion as the emotion inferred from the input text by the semantic prosody analysis engine 316. For example, a surprised face may be used as the talking head when the input text is inferred to convey the emotion of surprise. Additionally, or alternatively, the head image used for the talking head may be selected to match or otherwise correspond to the meaning of the input text as inferred by the semantic analysis engine 314. For example, if the input text is inferred to have a meaning related to France, the talking head may appear to be a French person or dressed in traditional French clothing.

The content renderer module 310 and may also include video beginning and/or ending sequences of talking head movements before and/or after the talking head “speaks” the input text. The beginning and/or ending sequences may include facial expressions or head movements such as a head turn, a head lift, a nod, a smile, a laugh, and the like. With inclusion of the beginning and/or ending sequences there may be a brief time at the start and/or end of the talking head video when the talking head is not actually talking The brief time may be, for example, approximately 0.5-2 seconds. In some implementations, the beginning and/or ending sequences may be selected randomly each time the content renderer module 310 renders a video. In other implementations, the beginning and/or ending sequences may be selected based on the meaning and/or emotion of input text. A user or creator of the talking head video may also manually select beginning and/or ending sequences in some implementations.

The video generation module 108 may be configured to generate an audio/video file that combines the audio file generated by the text-to-speech engine 312 and the video of the talking head generated by the content renderer module 310. The video generation module 108 may also add the input text as a subtitle, or other textual representation, to the audio/video file. Thus, the subtitles may become part of the video of the final audio/video file. As discussed above, either the audio and/or video portions of the audio/video file generated by the video generation module 108 may be based on one or both of the meaning and/or the emotion of the input. The video generation module 108 may combine the audio file from the text-to-speech engine 312 and the video of the talking head from the content renderer module 310 such that the mouth movements of the talking head are synchronized with the speech in the audio file in the final audio/video file generated by the video generation module 108.

Synchronization between the audio file and the video of the talking head may be implemented by many techniques one of which is a timing table. A timing table file may include multiple fields such as a word text field, a word duration field, a word type field, a word offset field, and a word length field. The word text field may include the text of a word from the input text for example “darkness.” The word duration field may indicate the amount of time necessary to “speak” the word in seconds or fractions of a second and/or by frame number of the video. The word type field may indicate whether the word is a normal word that is to be spoken, punctuation that may affect the cadence of speech but is not verbalized, or a period of silence. The word offset field may be used to indicate a start position for highlighting the word if the input text is displayed as a subtitle on the talking head video. The word length field may indicate the number of characters to highlight for the word when the word is displayed as a subtitle.

The video generation module 108 may also be configured to place a background image or video behind the talking head when creating the audio/video file. As discussed above, the background image may be any still or moving image or an absence of image such as a transparent region. The audio/video file created by the video generation module 108 may, in some implementations, be assembled from two image files and one audio file. Specifically, one of the image files may be an image of the talking head with a moving mouth generated by the content renderer module 310 and the other image file may be the background generated to appear behind the talking head. The audio file may be the file generated by the text-to-speech engine 312. Additionally, subtitles may be superimposed over the talking head and/or background images.

The background image may also be based on the meaning and/or emotion of the input text. For example, the video generation module 108 may automatically select a background image based on keywords (e.g., meaning inferred by the semantic analysis engine 314) from the input text. Input text that discusses the Eiffel tower may result in a background image of the Eiffel tower. Additionally, or alternatively, input text inferred to have sad emotional content may result in a background that is predominately a color such as blue or gray that may be associated with the emotional state of sadness. Conversely, input text that is inferred to be associated with a happy emotion may result in the video generation module 108 placing the talking head in front of a background of bright colors.

When generating a talking head video 102, the video generation module 108 may consume a configuration file that specifies values for the audio/video output. In some implementations, the configuration file may be implemented as an extensible markup language (XML) document. The configuration file may indicate a resolution of the output video (e.g., 631 pixels by 475 pixels) and a bit rate of the output video (e.g., 300 kB per second). The configuration file may also specify video and audio codecs to use when creating the output video. Additionally, length of a fade in and/or fade out period (e.g., 1.5 seconds) at the start and end of the video may be specified by the configuration file.

Although the examples illustrating correlation between meaning and/or emotion of the input text in the and the resulting selections of a voice, a talking head image, and/or a background show a positive correlation (e.g., the selected feature matches the meaning and/or emotional content of the input text) functioning of the modules in the computing device 302 is not limited to only positive correlations. For example, selections of voice, talking head image, and/or background may be based on but opposite to the inferred meaning and/or emotion of input text. The resulting discordance between the input text and the appearance or sound of the final audio/video file created by the video generation module 108 may be merely amusing or may be used as a pedagogical tool. For example, a teacher may produce talking head videos with a component that does not match the meaning and/or emotion present students the task of identifying what is discordant and why based on the students' own abilities to analyze the meaning and/or emotion of foreign-language input text.

The computing device 302 may also include additional computer-readable media such as one or more storage devices 318 which may be implemented as removable storage, non-removable storage, local storage, and/or remote storage. The storage device(s) 318 and any associated computer-readable media may provide storage of computer readable instructions, data structures, program modules, and other data. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The storage device(s) 318 may contain multiple data stores or databases of information usable to generate talking head videos. One of the data stores may include voices 320 for the speech generated by that text-to-speech engine 312. The voices stored in the voices 320 data store may be implemented as text-to-speech algorithms that generate different sounding output audio files from the same input text. As discussed above, the user of the computing device 302 may manually select a voice to use when creating a talking head video. In other implementations, the voice may be selected by the text-to-speech engine 312 based on meaning inferred from the input text, emotion inferred from the input text, or by another technique (e.g., random selection).

Multiple head images 322 may also be stored in the storage device(s) 318. The head images 322 may be used by the content renderer module 310 to create talking head images. The head images 322 in the data store may be still pictures or video clips of actual people. Users may also provide their own images or videos to the head images 322 data storage in order to generate a talking head video of themselves, their friends, etc. A head image may be selected from the head images 322 data store for creation of a talking head video manually by the user or, in other implementations, automatically based upon meaning and/or emotion inferred from the input text. The talking head image may also be selected from the head images 322 data store based on other criteria such as use of a default head image or random selection of one of the head images.

A talking head video 102 may utilize more than one head image 332 and more than one voice 320. Each sentence, or other logical portion, of input text may be associated with a different one of the head images 332 and/or a different one of the voices 320. The semantic analysis engine 314 and/or the semantic prosody analysis engine 316 may select a head image 332 and/or voice 320 for each sentence of the input text using any of the techniques described above. For example, an input text that includes sentences associated with two, or more, different speakers may be rendered by the video generation module 108 as an audio/video file that has multiple heads, each with an appropriate voice, “talking” in turn.

In one implementation, multiple talking heads may be shown simultaneously in the final audio/video file. In another implementation, the video images may show transitions between talking heads so that only the head image 332 which is current “speaking” is shown. One type of transition may incorporate movements of the talking head itself For example, a first talking head may look straight ahead while speaking (i.e., similar to a person looking directly at the camera) and then look toward an edge of the screen (e.g., left, right, top, bottom) when finished speaking A standard video transition such as a fade or swipe may change from the view of the first talking head to a view of the second talking head. The view of the second talking head image may begin with the second talking head image looking in an opposite direction than the first talking head image. Thus, if the first talking head ends by looking left then after the transition the second talking head may begin by looking to the right. After turning to look straight ahead, the second taking head may begin speaking This type of transition may be repeated for any number of talking heads.

A backgrounds 324 data store may also be included within the storage device(s) 318. The backgrounds 324 data store may include multiple backgrounds both static and/or moving for inclusion in a talking head video. For example, the backgrounds 324 data store may include a series of pictures, images, textures, patterns, and the like similar to selections available for a computer desktop image. The backgrounds 324 data store may also include moving images both computer-generated and video files. Backgrounds may be selected from the backgrounds 324 data store in any one of multiple ways such as manual selection by user, selection based upon meaning and/or emotion of input text, or in another way such as random selection.

The computing device 302 may also include input device(s) 326 such as a keyboard, mouse, pen, voice input device, touch input device, stylus, and the like, and output device(s) 228 such as a display, monitor, speakers, printer, etc. All these devices are well known in the art and need not be discussed at length.

The computing device 302 may also contain communication connection(s) 330 that allows the computing device 302 to communicate with other devices and/or a communications network. Communication connection(s) 330 is an example of a mechanism for receiving and sending communication media. By way of example, and not limitation, communication media includes wired media such as a wired network or direct-wired connection, and wireless media such as acoustic, radio frequency (RF), infrared, and other wireless media.

The computing device 302 presents an illustrative architecture of these components on a single system. However, these components may reside in multiple other locations, servers, or systems. For example, any of the components or modules may be separately maintained on other computing devices communicatively connected to one another through a network or cloud computing implementation. Furthermore, two or more of the components may be combined.

### Illustrative Architectures

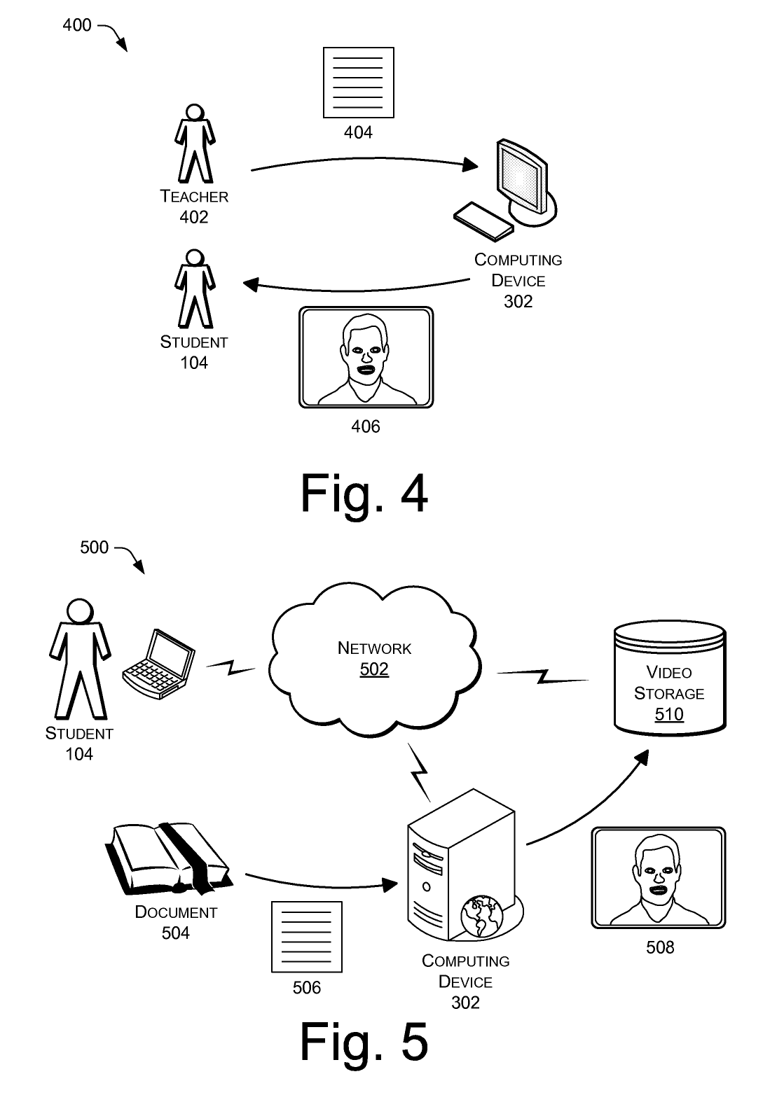

FIG. 4 shows an illustrative architecture 400 of the computing device 302 used as a local computing device to generate talking head videos for language learning. The computing device 302 may be located in a classroom and available for use by a teacher 402 and/or a student 104. The teacher 402 may select input text 404 to provide to the computing device 302. The input text 404 may be text that the teacher 402 has authored himself or herself, text from a textbook, a website, or any other source. The teacher 402 may enter the input text 404 into the computing device 302 by manual entry such as typing, by copying text from an electronic document (e.g., cut-and-paste), by selecting an entire electronic document, or by another technique.

The computing device 302 may generate an audio/video file as discussed above, and thus, output a talking head video 406. The talking head video 406 may be presented to the student 104. The student 104 may repeatedly watch the talking head video 406 while practicing pronunciation of the input text. The teacher 402 may select the head image for the talking heads, the voice for the talking head, and a background for inclusion in the talking head video 406. For example, the teacher 402 may select a head image and a voice that are likely to capture the interest of the student 104 who will view the talking head video 406. The teacher 402 may also “brand” the talking head video 406 by selecting a background image that includes the name or other representation of the school at which the teacher is teaching.

In some implementations, the same computing device 302 maybe used by the teacher 402 to enter the input text 404 and by the student 104 to view the talking head video 406. For example, the computing device 302 may include a projector as an output device and the talking head video 406 may be projected on a screen in the classroom for multiple students to view simultaneously. During playback of the talking head video 406, the student 104 viewing the talking head video 406 may alter aspects of the playback such as slowing down playback, zooming in on the mouth, and such as shown in FIG. 2. The teacher 402 may also manipulate playback such as by having the student 104 initially view and listen to the talking head video 406 without subtitles in order to practice listening comprehension and then turning on subtitles so that the student 104 can also practice reading.

Alternatively, the computing device 302 on which the teacher 402 generates the talking head video 406 may be different from the computing device on which the student 104 views the talking head video 406. For example, the teacher 402 may use his or her desktop computer to create an audio/video file that is the talking head video 406 and distribute this file to a computing device of the student 104.

FIG. 5 shows an illustrative architecture 500 of the computing device 302 used as a network computing device to provide talking head videos for language learning. The computing device 302 may be implemented as a networked device, for example, as a Web server. The student 104 may use a separate computing device such as a laptop computer, mobile phone, etc. to access a network 502. The network 502 may be any type of data communications network such as a local area network, wide area network, the Internet, and the like.

In one implementation, the computing device 302 may provide access to an electronic document 504 containing text such as a webpage, online dictionary, encyclopedia, movie script, and the like. Input text 506 may be automatically extracted from the electronic document 504. For example, the electronic document 504 may be an electronic dictionary containing numerous words, definitions, and example sentences. The computing device 302 may extract each of the example sentences from the electronic dictionary as input text 506 to use for creating talking head videos 508.

Creating the talking head videos 508 in advance before the student 104 or other user wishes to view the talking head videos 508 may decrease the delay between receiving a request for the talking head video 508 and displaying the talking head video 508. Depending on factors such as the processing speed of the computing device 302, generating a talking head video 508 from the input text 506 may take a user-perceivable amount of time such as several seconds or minutes. Pre-generation and storage of the talking head videos 508 in a video storage 510 may eliminate any such delay.

The audio/video files generated by the computing device 302 may be in any conventional video format such as Moving Pictures Experts Group (MPEG) format (MPEG-4, etc.), Windows Media® Video file (WMV), Audio Video Interleave File format (AVI), and the like. Once generated and finalized the audio/video file containing the talking head video 508 may be similar to any other audio/video file and able to be shared, copied, stored, and played just as other audio/video files of the same format.

The video storage 510 may contain files of all the talking head videos 508 created by the computing device 302 from the electronic document 504. The computing device 302 may present contents of the electronic document 504 (e.g., an electronic dictionary) to the student 104 via the network 502 such as by, for example, including all or part of the electronic document 504 on a webpage. The representation of the electronic document 504 may include the talking head videos 508 generated by the computing device 302. For example, a webpage may contain words, definitions, and example sentences from the electronic dictionary with links next to the example sentences that, when activated by the student 104, cause playback of a talking head video 508 that corresponds to the example sentence.

The student 104 may also use the computing device 302 to generate talking head videos 508 from input text that the student 104 provides via the network 502. Rather than clicking on a video link next to an example sentence, the student 104 may enter text into a text box and request that the computing device 302 generate a talking head video 508. The computing device 302 may initially check to see if it has already generated a talking head video 508 based on the same input text and if such video is available in the video storage 510. If not, the computing device 302 may generate a new talking head video 508 responsive to the input text provided by the student 104.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that can be implemented in hardware, software, or a combination of hardware and software. For discussion purposes, the processes are described with reference to the systems, architectures, and operations shown in FIGS. 1-5. However, the processes may be performed using different architectures and devices.

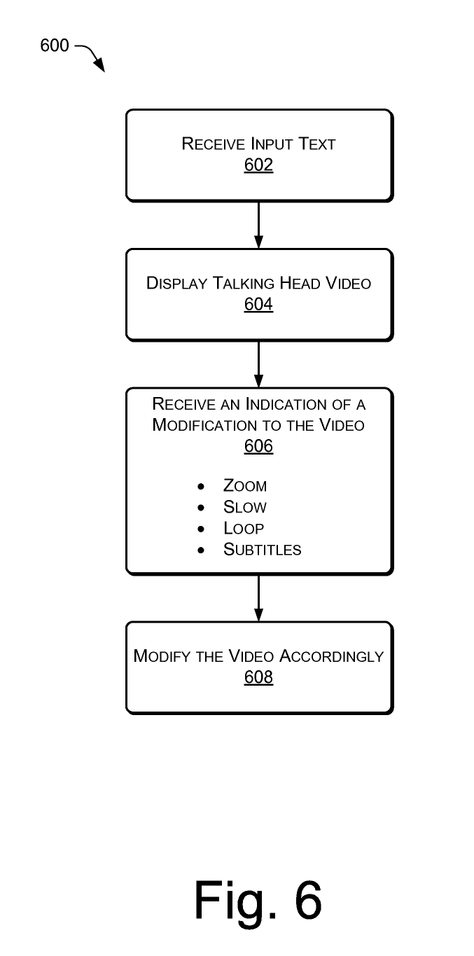

FIG. 6 illustrates a flowchart of a process 600 of modifying a talking head video. At 602, input text is received. The input text may be received from a human source or a computer source. For example, the input text may be received from a student studying a foreign language or a teacher teaching a foreign language. The input text may also be received from a computer that mines or extracts textual passages from an electronic document.

At 604, the talking head video is displayed. The video may show a talking head having computer-generated mouth movements based on the input text and computer-generated audio also based on input text. The mouth movements of the talking head may be generated by the content renderer module 310 and the audio may be generated by the text-to-speech engine 312 as discussed above. The movement of the mouth and the playback of the audio may be synchronized so that the talking head speaks the input text. In other words, the mouth of the talking head moves in a similar way as a native speaker's mouth would while the audio reproduces the corresponding sound of the input text. Thus, the talking head appears to be speaking or lip-synching the words of the computer-generated audio.

Display of the talking head video at 604 may also include a display of a background behind the talking head and/or subtitles corresponding to the text received at 602. The subtitles may be displayed in the video as the talking head speaks a corresponding portion of the input text. For example, if the word “darkness” is included in the sound portion of the video, a subtitle showing “darkness” may be displayed at the same time the sound of the word “darkness” is generated.

At 606, an indication of a modification to the video is received. The indication may be received from a foreign language student viewing the video in order to modify playback of the video in a way that enhances language learning. The modification may include any of the controls shown in FIG. 2. The modification may be a zoom command to zoom in on the mouth of the talking head. The modification may additionally or alternatively be a slow-speed playback command to decrease the playback speed of the video. Also, modification may be a loop command to replay continuously a portion of the video selected by the viewer. The loop command may be used together with either or both of the zoom command and the slow-speed playback command. When the display at 604 includes display of input text as subtitles an additional modification may include turning off the subtitles.

At 608, playback of the video is modified in accordance with the indication received at 606. For example, if the indication is for slow-speed playback, such as by a viewer of the video activating the slow 218 control shown in FIG. 2, playback of the talking head video will be slowed.

Process 600 may be implemented by a student or other viewer of the talking head video interacting with a video player. The video player may be any type of software and/or hardware capable of reproducing and controlling playback of a video such as Adobe® Flash Player™ or Silverlight™ Media Player. Process 600 may, for example, be implemented by the architecture shown in FIG. 4.

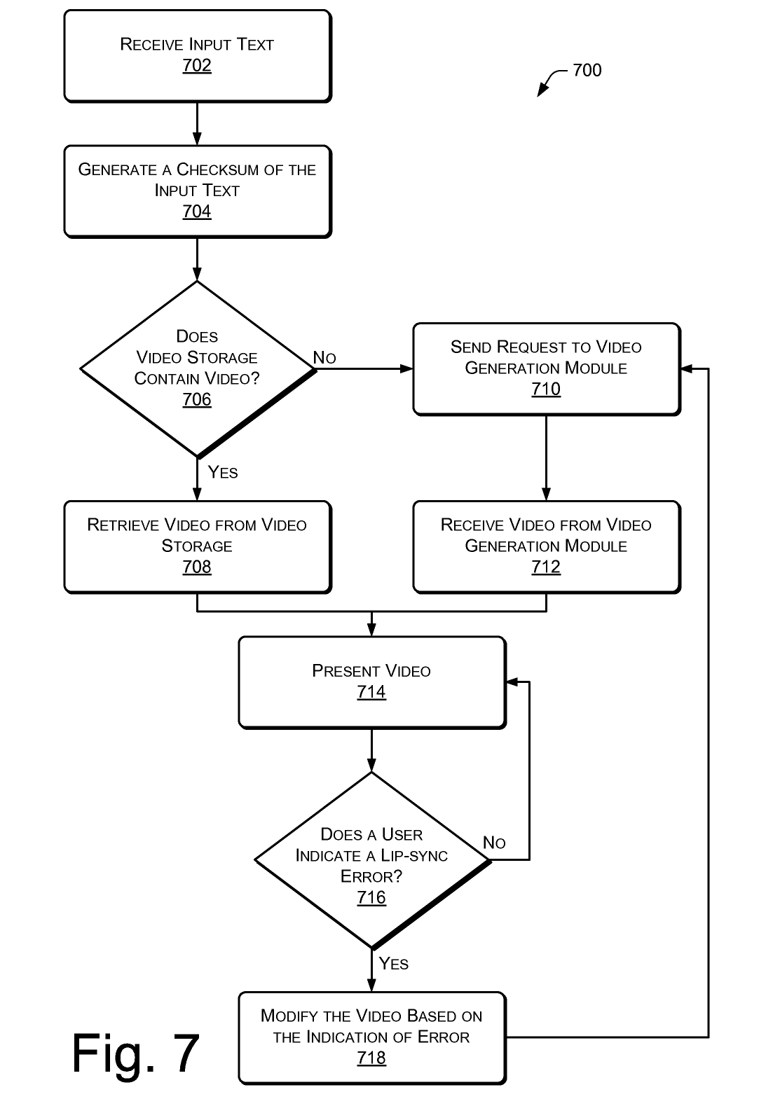

FIG. 7 illustrates a flowchart of a process 700 for obtaining talking head videos and identifying lip-sync errors. At 702, input text is received. The input text may be provided by human user such as a student or teacher. For example, the input text may be entered by a user into a language learning website. For example, a visitor to a website with an online dictionary may input text into a text box in order to receive a talking head video so that he or she can practice pronunciation of the input text.

Alternatively, the input text may be automatically captured from an electronic document such as an electronic dictionary. The electronic dictionary may contain example sentences or words in the dictionary and those example sentences may be automatically captured from the electronic dictionary. The automatic capture may be based on tags associated with the example sentences such as meta-tags that identify those sentences as example sentences. The automatic capture may also be based on analysis of text characters in the electronic document and the location of example sentences may be determined based upon character patterns. For example, a sentence in English may be identified as a sentence by a capital letter at the beginning and a period at the end.

At 704, a checksum of the input text is generated. The checksum may be generated by any type of checksum or hashing algorithm such as, for example, message-digest algorithm 5 (MD5). The checksum creates a code that is highly likely to be unique to the input text. Thus, the checksum can serve as a unique and compact identifier for the input text received at 702.

At 706, it is determined if a video storage includes a video associated with the checksum. The video storage may be similar to the video storage 510 shown in FIG. 5. If a video existing in the video storage already has the same checksum, it is assumed that the video was generated from the same input text. When the video storage does include a video associated with the checksum, process 700 proceeds along the “yes” path to 708. However, when the video storage does not include a video associated with the checksum, process 700 proceeds along the “no” path to 710.

At 708, the video associated with the checksum is retrieved from the video storage. Retrieval may include transferring the video file from the video storage to storage or memory on another computing device. Retrieval may also include loading the video into a website or other type of video player so that it is able to be viewed.

At 710, when none of the videos in the video storage are associated with a checksum that matches the checksum generated at 704, a request is sent to a video generation module to generate a video from the input text received at 702. The video generation module may be similar to video generation module 108 and/or other modules/engines shown in FIG. 3.

At 712, the video generated by the video generation module is received from the video generation module. This video may also be placed into the video storage for future use if the same input text is subsequently received. Whether received from the video storage at 708 or received as response from the video generation module at 712, the received video shows a virtual language teacher which includes a talking head with a mouth that moves in synchronization with speech generated from the input text received at 702.

At 714, the video received at 708 or at 712 is presented. The presentation may be to a language student, to a teacher, or to any other viewer. In some implementations, the video may be presented on a language learning website. For example, the video may be shown in a video player window embedded in or that pops up over the language learning website. Presenting the video on the language learning website may include presenting the video itself, or a link to the video, in proximity to the presentation of the input text and the presentation of the input text translated into a different language. For example, a website designed for speakers of Mandarin Chinese to learn English may show an example sentence in English with the translation in Mandarin Chinese and a small link such as a television icon next to the example sentence. When the link is activated or selected by a user of the website, the talking head video generated from that example sentence may be presented on the website.

At 716, an indication of a lip sync error may be received. The user may indicate that the lip-sync error exists when the mouth of the talking head does not move in synchronization with speech generated from the input text. Indication of a lip-sync error may be provided by, for example, the user activating a lip-sync error 226 command as shown in FIG. 2. If the video is presented on a website such as a language learning website many people may view the same video and notice the same error. Collecting anonymous indications of the lip-sync error from multiple viewers may provide a convenient and reliable way for an entity maintaining the language learning website to learn of errors.

If the indication of a lip sync error is not received, process 700 may proceed along the “no” path and return to 714 where the video may be presented as long as the user desires.

However, if an indication of a lip-sync error is received at 716, process 700 proceeds along the “no” path to 718. At 718, the video is modified based on the indication of the lip-sync error received at 716. In order to correct the lip-sync error, the video may be regenerated such as, for example, by modifying the timing table discussed above. Additionally or alternatively, the underlying algorithms used to create the video may be modified and the video regenerated. Thus, process 700 proceeds from 718 to 710 and a request for regeneration of the video is sent to the video generation module.

### CONCLUSION

The subject matter described above can be implemented in hardware, software, or in both hardware and software. Although implementations have been described in language specific to structural features and/or methodological acts, it is to be understood that the subject matter defined in the appended claims is not necessarily limited to the specific features or acts described above. Rather, the specific features and acts are disclosed as illustrative forms of illustrative implementations of generating a virtual language teacher.

1. A foreign-language training system comprising:
a processor;
a memory communicatively coupled to the processor;
a text analysis module stored in the memory and executable at the processor comprising:
a text-to-speech engine configured to generate an audio file of speech corresponding to a foreign-language input text;
a semantic analysis engine configured to infer a meaning of the foreign-language input text; and
semantic prosody analysis engine configured to infer an emotion of the foreign language input text;
a content renderer module stored in the memory and executable at the processor to generate a video of a talking head having mouth movements based at least in part on the foreign-language input text; and
a video generation module stored in the memory and executable at the processor to generate an audio/video file based at least in part on the meaning and/or the emotion of the foreign-language input text, the audio/video file combining the audio file of speech derived from the foreign-language input text and the video of the talking head such that the mouth movements of the photorealistic talking head are synchronized with the speech in the audio file.

2. The system of claim 1, wherein the text-to-speech engine is configured to select a voice for the audio file of speech derived from the foreign-language input text based at least in part on the meaning and/or emotion of the foreign-language input text.

3. The system of claim 1, wherein the content renderer module is configured to select an image for the talking head based at least in part on the meaning and/or emotion of the foreign-language input text.

4. The system of claim 3, wherein the content renderer module is configured to select a first image for the talking head for a first portion of the foreign-language input text and select a second image for the talking head for a second portion of the foreign-language input text.

5. The system of claim 1, wherein the video generation module is configured to place a background image or video behind the photorealistic talking head in the audio/video file.

6. The system of claim 5, wherein selection of the background image or video is based at least in part on the meaning and/or emotion of the foreign-language input text.

7. The system of claim 1, wherein the video generation module is configured to add the foreign-language input text as a subtitle to the audio/video file.

8. One or more computer-readable media storing computer-executable instructions that, when executed by a processor, configure the processor to perform acts comprising:
receiving an input text;
receiving a video of a virtual language teacher comprising a talking head having a mouth that moves in synchronization with speech generated from the input text; and
presenting the video.

9. The one or more computer-readable media of claim 8, wherein the input text is automatically captured from an electronic document.

10. The one or more computer-readable media of claim 9, wherein the electronic document comprises an electronic dictionary including example sentences for words in the dictionary and the input text comprises the example sentences.

11. The one or more computer-readable media of claim 8, further comprising:
generating a checksum of the input text;
determining if a video storage includes a video associated with the checksum;
when the video storage includes a video associated with the checksum, the receiving comprises retrieving the video associated with the checksum from the video storage; and
when the video storage does not include a video associated with the checksum, the receiving comprises requesting a video generation module to generate the video of the virtual language teacher and receiving the video of the virtual language teacher from the video generation module.

12. The one or more computer-readable media of claim 8, wherein the presenting the video comprises presenting:
the video or a link to the video in proximity to a presentation of the input text, and
a translation of the input text in a different language.

13. The one or more computer-readable media of claim 8, further comprising receiving an indication of a lip-sync error when the mouth of the talking head does not move in synchronization with speech generated from the input text.

14. The one or more computer-readable media of claim 13, further comprising modifying the video of a virtual language teacher based on the indication of the lip-sync error.

15. A computer-implemented method of teaching a foreign language comprising:
under control of one or more processors configured with executable instructions,
receiving an input text;
displaying a video showing a talking head having computer-generated mouth movements based at least in part on the input text and computer-generated audio based at least in part on the input text such that the talking head speaks the input text;
receiving a request for a modification to a playback of the video; and
modifying playback of the video in accordance with the request.

16. The computer-implemented method of claim 15, wherein the request comprises a zoom command to zoom in on the mouth of the talking head.

17. The computer-implemented method of claim 15, wherein the request comprises a slow-speed playback command to decrease the playback speed of the video.

18. The computer-implemented method of claim 15, wherein the request comprises a loop command to continuously replay a portion of the video.

19. The computer-implemented method of claim 15, wherein displaying the video comprises displaying the input text as subtitles that are displayed in the video as the talking head speaks a corresponding portion of the input text.

20. The computer-implemented method of claim 19, wherein the modification comprises turning off the subtitles.
